(19) United States
(12) Patent Application Publication
(10) Pub. No.: US 2015/0142673 A1
(43) Pub. Date: May 21, 2015

(54) METHODS AND SYSTEMS FOR TOKEN REQUEST MANAGEMENT

(71) Applicants: Mark Nelsen, Oakland, CA (US); John Sheets, San Francisco, CA (US)

(72) Inventors: Mark Nelsen, Oakland, CA (US); John Sheets, San Francisco, CA (US)

(21) Appl. No.: 14/546,999

(22) Filed: Nov. 18, 2014

Related U.S. Application Data
(60) Provisional application No. 61/905,823, filed on Nov. 18, 2013.
(60) Provisional application No. 61/906,870, filed on Nov. 20, 2013.

(51) Int. Cl. G06Q 20/38

(52) U.S. Cl. CPC G06Q 20/385
USPC 705/76

(57) ABSTRACT

Embodiments of the present invention are directed to methods and systems for providing a payment token issuance system using account issuer-defined payment token request rules generated and stored by a token issuer computer. The token issuer computer allows an account issuer to define payment token request rules, and the token issuer computer can automatically apply the payment token request rules to a payment token request without requiring additional decisioning by the account issuer.

### CROSS-REFERENCES TO RELATED APPLICATIONS

This application claims the benefit of priority U.S. Provisional Application No. 61/905,823, filed Nov. 18, 2013, titled “METHODS AND SYSTEMS FOR TOKEN REQUEST MANAGEMENT USING A RISK MODEL,” and U.S. Provisional Application No. 61/906,870, filed Nov. 20, 2013, titled “METHODS AND SYSTEMS FOR TOKEN REQUEST MANAGEMENT USING A RISK MODEL,” which are incorporated by reference in their entirety for all purposes.

### BACKGROUND

The Internet has made it easy for consumers to conduct transactions. However, it has also increased the risks of fraudulent transactions, as well as the risk of user data being compromised. In a traditional electronic payment transaction, a consumer's primary account number (PAN) information is exposed to various entities involved during the transaction lifecycle. The PAN may be passed from a merchant terminal, to an acquirer system, a payment processing network, payment gateways, etc. Because the PAN can be exposed at various points in the transaction lifecycle, payment “tokens” have been developed to conduct payment transactions. A payment token serves as an additional security layer to the PAN and in effect becomes a proxy/surrogate to the PAN. Thus, the payment token may be used in place of PAN while initiating payment or submitting transactions. The use of payment tokens instead of PANs can reduce the risk of fraudulent activity since the real PAN is not exposed.

In transaction or other authorization systems, tokens can be used in place of secure data (e.g., passwords, payment account data) for security purposes. Typical token issuing processes may require multiple messages in order to authenticate a PAN and/or a cardholder, which is then used to determine whether a token should be issued. However, while the token requester (e.g., merchant or consumer) may have additional information that may be useful, current systems may not be utilizing this data to make its decisioning.

Thus, there is a need for new and enhanced methods of ensuring a more secure systems for token issuance that can provide greater security and assurance that a token should be issued for a particular PAN. One way to enhance the security of tokenization systems is to provide for a centralized token vault that can distribute tokens and control them. However, this can be problematic since many parties in a payments ecosystem may want to control how tokens are issued or used.

Embodiments of the present invention address the above problems and other problems.

### BRIEF SUMMARY

Embodiments of the present invention may be directed at optimizing the process for issuing payment tokens by providing account issuers with the ability to customize and define payment token request rules. Embodiments of the present invention provide a user interface that allows issuers to define strategies that manage payment token requests. The strategies may be complex based on a set of parameters that the account issuer defines. Account issuers may be able to create and activate payment token request rules in real-time. The payment token request rules can be used to determine whether a payment token request should be approved, denied, or sent for additional decisioning.

In some embodiments, when a payment token request rule is triggered, the account issuer may be able to perform an additional risk analysis to determine whether a payment token should be issued.

One embodiment of the invention is directed to a method comprising receiving a set of parameters from a client computer operated by an account issuer. The method further comprises generating a payment token request rule based on the set of parameters and storing the payment token request rule. The method further comprises receiving a payment token request message, and applying the payment token request rule to the payment token request message. When the payment token request rule is satisfied, the method further comprises issuing a payment token.

Another embodiment of invention is directed to a computer comprising a processor and a computer readable medium coupled to the processor, the computer readable medium comprising code, executable by the processor for implementing a method. The method comprises receiving a set of parameters from a client computer operated by an account issuer. The method further comprises generating a payment token request rule based on the set of parameters and storing the payment token request rule. The method further comprises receiving a payment token request message, and applying the payment token request rule to the payment token request message. When the payment token request rule is satisfied, the method further comprises issuing a payment token.

Another embodiment of invention is directed to a method comprising receiving from a token issuer computer a user interface for providing a set of parameters to generate a payment token request rule. The method further comprises generating the set of parameters and sending the set of parameters to the token issuer computer.

Another embodiment of invention is directed to a computer comprising a processor and a computer readable medium coupled to the processor, the computer readable medium comprising code, executable by the processor for implementing a method. The method comprises receiving from a token issuer computer a user interface for providing a set of parameters to generate a payment token request rule. The method further comprises generating the set of parameters and sending the set of parameters to the token issuer computer.

These and other embodiments of the invention are described in further detail below with reference to the Drawings and the Detailed Description.

### BRIEF DESCRIPTION OF THE DRAWINGS

FIG. 1 depicts a block diagram illustrating a transaction processing system according to an embodiment of the present invention.

FIG. 2 depicts a block diagram of a token issuer computer system according to an embodiment of the present invention.

FIG. 3 shows an exemplary flow diagram for a method of generating payment token request rules, according to an embodiment of the present invention.

FIG. 4 shows an exemplary flow diagram for a method of applying a payment token request rule to a payment token request according to an embodiment of the present invention.

FIG. 5 shows an exemplary flow diagram for an alternative method of applying a payment token request rule to a payment token request according to an embodiment of the present invention.

FIG. 6 shows a depiction of a rules management user interface according to an embodiment of the present invention.

FIG. 7 shows a depiction of a rules definition user interface according to an embodiment of the present invention.

FIG. 8A shows a depiction of a rules editor user interface according to an embodiment of the present invention.

FIG. 8B shows a depiction of a modified rules definition user interface according to an embodiment of the present invention.

FIG. 9 shows a block diagram of a computer apparatus according to an embodiment of the present invention.

### DETAILED DESCRIPTION

Embodiments of the present invention are directed to methods and systems for that allow parties such as issuers to define token request rules. A payment token is a substitute for a real payment account number. Payment tokens can be used in place of real account numbers such as personal account numbers (“PANs”) to reduce their exposure and to reduce the chance that the real account numbers will be obtained by unauthorized persons. In a large payments infrastructure, many parties may have the need to define the parameters for payment token use, although not every party will be issuing payment tokens. It is more desirable for one entity (e.g., a token vault) to maintain and generate payment tokens so that there some central control and distribution of payment tokens.

Embodiments of the present invention can optimize the process for issuing payment tokens for financial transactions by using pre-defined payment token request rules that can be used to determine whether a payment token should be issued. These pre-defined payment token request rules can be provided to different entities (e.g., issuing banks) so that tokens may be generated according to their preferences. By doing so, payment tokens can be easily customized according to some standard protocols and a central payment token issuer server computer can perform rigorous and standardized fraud analyses to any token requests. Thus, entities such as issuing banks need not create or maintain fraud rules for token requests. Also, by performing the payment token request decision processing on behalf of the account issuer, embodiments of the present invention can reduce the messaging involved in typical payment token issuing systems, as well as decrease the amount of time and system resources that would be otherwise needed if each entity that wanted to control the way in which payment tokens are issued and used wanted to create its own fraud detection and payment token issuance infrastructure.

Prior to discussing embodiments of the invention, descriptions of some terms may be helpful in providing a better understanding of the invention.

A “token” may include a substitute identifier for information. For example, a payment token may include an identifier for a payment account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “token issuer” may refer to an entity operating one or more server computers in a token service system that generates, processes and maintains tokens. The token issuer may include or be in communication with a token vault where the generated tokens are stored. Specifically, the token vault may maintain a mapping between a token and a primary account number (PAN) represented by a token.

The term “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

The term “payment token request message” may include a message sent from one entity to another entity requesting that a payment token be provided. In some embodiments, the payment token request message may include a plurality of data elements including user data, a token requestor device, account data, and other data that may be used by the token issuer to make a determination as to whether a payment token should be issued. The payment token request message may be sent from the token requestor to the token issuer.

A “risk analysis” may include a process for determining a risk level. The risk analysis may use data to calculate or determine a level of risk associated with a transaction. The risk analysis may use data elements received in a payment token request message to determine a risk score for the payment token request.

The term “identifier” may refer to any information that may be used to identify information. For example, a payment account identifier may be an account number associated with a financial account (e.g., a credit card number or debit card number), or may be a special identifier generated randomly or according to a predetermined algorithm, code, or shared secret. In another example, an account issuer identifier may be used to uniquely identify an account issuer.

A “risk score” may include results of a risk analysis or evaluation. A risk score may be in the form of a numeric or an alphanumeric value, such as a number from 1-10 or a letter from A-Z. A risk score may indicate a relative degree of risk in a particular situation, such as a transaction. In some cases, a higher risk score may indicate high risk, while a lower risk score may indicate low risk.

A “threshold” may refer to a boundary value. A value compared to the value of the threshold may be used to determine an action to perform. A threshold may be a numerical value in which values below the threshold result in the performance of a first set of actions, and values above the threshold result in the performance of a second set of actions. In some embodiments, the threshold may be a pre-established value.

A “token vault” may include any hardware, software, firmware, or combination of the preceding for storing and facilitating the retrieval of information. The token vault may use any of a variety of data structures, arrangements, and compilations to store and facilitate the retrieval of information.

An “account issuer” may include an entity that issues an account. An account issuer is typically a business entity, such as a bank, which creates and maintains financial accounts for users.

A “risk score” may include a result of a risk analysis or evaluation. A risk score may be in the form of an alphanumeric value such as a number from 1-10 or a letter from A-Z. The risk score may indicate a relative risk associated with an action or request.

A “password” may include an expression used for unique identification. The password may be alphanumeric, or composed of only numbers or only letters. Passwords are not limited to strings of characters, and may include biometric data associated with a user, a bar code, QR code, or an image or graphic.

A “payment token request rule” may refer to a rule associated with a payment token request. In some embodiments, the payment token request rule may be in a token issuer system, and may be a customizable rule based on parameters provided by another entity (e.g., an account issuer). Each payment token request rule may allow customization as to conditions and may allow for further processes or actions to be taken if the payment token request rule is triggered. Each payment token request rule may further allow rule conditions to be established based on a number of criteria. Some payment token request rules may be business rules that indicate whether a payment token request from a token requestor should be accepted, rejected, or submitted for further review.

The term “authorization request message” may include a message sent to request an authorization. An authorization request message may comply with ISO 8583, which is a standard for the exchange of message in a financial transaction system. An authorization request message according to other embodiments may comply with other suitable standards. Typically, an authorization request message is generated by a server computer and sent to an issuer computer.

The term “authorization response message” may include a message sent in response to authorization request message. An authorization response message may comply with ISO 8583, which is a standard for the exchange of message in a financial transaction system. An authorization response message according to other embodiments may comply with other suitable standards. Typically, an authorization response message is generated by an issuer computer after a decisioning process.

The term “client computer” may include any suitable computational device that is capable of interacting with a server computer. Examples of client computers may include mobile phones, laptop computers, tablet computers, desktop computers, etc.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

### I. Exemplary Systems

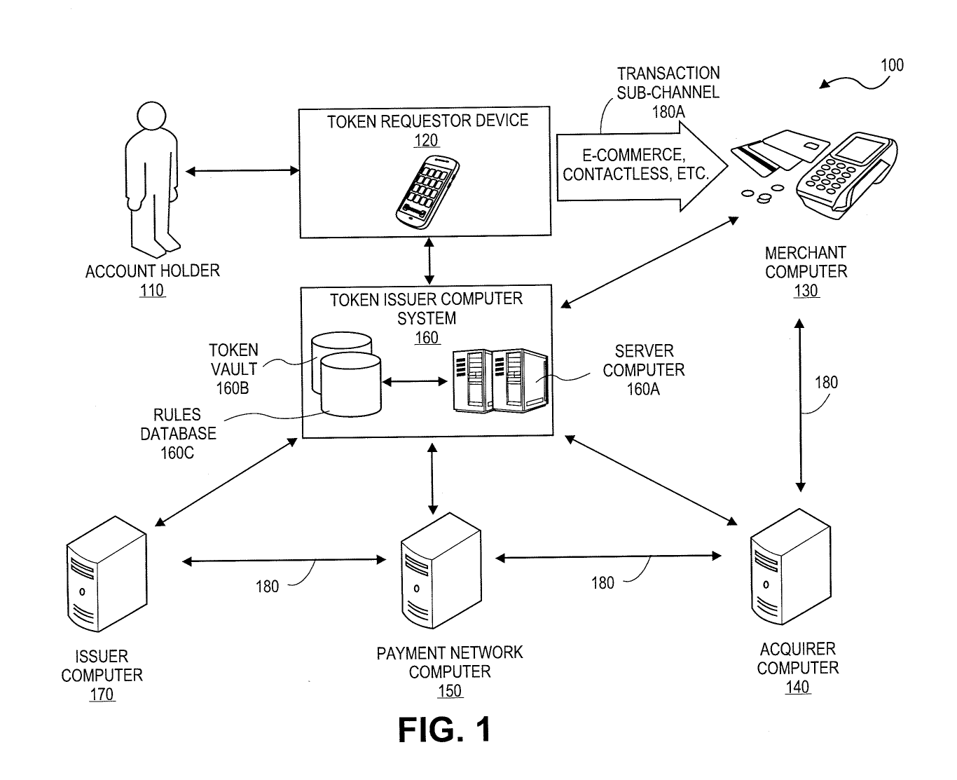

FIG. 1 depicts a block diagram illustrating a transaction processing system 100 according to an embodiment of the present invention. For simplicity of illustration, a certain number of components are shown is shown in FIG. 1. It is understood, however, that embodiments of the invention may include more than one of each component. In addition, some embodiments of the invention may include fewer than all of the components shown in FIG. 1. In addition, the components in FIG. 1 may communicate via any suitable communication medium (including the Internet), using any suitable communications protocol.

The transaction processing system 100 may comprise an account holder 110 that may use a token requestor device 120 to request a payment token. Although the token requestor device 120 is operated by the account holder 110 in FIG. 1, it can be operated by any other suitable entity including a merchant, an acquirer, etc. As shown in FIG. 1, the token requester device 120 may be in communication with a merchant computer 130 and a token issuer computer system 160. The token issuer computer system 160, a merchant computer 130, an acquirer computer, a payment network computer 150, and an issuer computer 170 may all be in communication with each other. The various entities may be capable of communicating over any suitable network connection or communications system including the Internet and/or any cellular telephone network.

The token issuer computer system 160 may include a token issuer server computer 160A, and a token vault 1608 and rules database 160C coupled to the token issuer computer 160A. In some embodiments, the token issuer computer system 160 may be characterized as token issuer and a token verifier. In other embodiments, the token issuer and the token verifier may be separate entities, where the token issuer can generate tokens, while the token verifier can validate or verify tokens issued by the token issuer.

The transaction processing system 100 may further comprise an acquirer computer 140, a payment network computer 150 and an issuer computer 170. The token requestor device 120 may be configured to communicate with the merchant computer 130, the acquirer computer 140, the payment network computer 150, and the issuer computer 170 through a transaction channel 180. The transaction channel 180 may include a communication path between one or more of the token requestor device 120, the merchant computer 130, the acquirer computer 140, the payment network computer 150, and the issuer computer 170. The transaction channel 180 may be a communication channel, which allows for communication with the issuer computer 170 during an electronic payment transaction

The transaction channel 180 may include one or more sub-channels. Sub-channels 180A that may provide for communication between the token requestor device 120 and the merchant computer 10 may include a contactless or contact communication sub-channel between the merchant computer 130 and the token requester device 120. They may also include a communication sub-channel between the merchant computer 130 and the token requester device 120 that utilizes a communication network such as the Internet.

The account holder 110 can be a user of a portable consumer device (e.g., a credit card). The account holder 110 may also be referred to as a “consumer” in some contexts. The account holder 110 may utilize a communication device (e.g., a mobile phone) that can serve as the token requestor device 120 during a transaction with a merchant.

The token requestor device 120 may be a device that can request a payment token. In some embodiments, it may be associated with a payment account of the account holder 110. The token requestor device 120 may be, without limitation, a mobile device such as a mobile phone, a tablet, a PDA, a notebook computer, a key fob, or any suitable device. In other embodiments, the token requestor device 120 may be a stationary device such as a desktop computer. In some embodiments, the token requestor device 120 may include a digital or mobile wallet and/or a payment application that may be associated with one or more payment accounts of the account holder 110. In some embodiments, the token requestor device 120 may be configured to display a machine readable code such as a QR code or barcode. The token requestor device 120 may also include a camera or a scanning device capable of scanning machine readable code.

Although not shown in FIG. 1, in some embodiments, the account holder 110 may use a token requestor device 120 to interface with a token requestor that may be provided through a remote computer (e.g., mobile wallet provider), etc. Accordingly, the account holder 110 may use token requestor device 120 to obtain a token that is stored by a remote server computer operated by a mobile wallet provider that may have previously obtained a payment token from a token issuer computer system 160. Accordingly, there may be multiple token requestor devices in some embodiments and/or a communication device of the account holder 110 (e.g., mobile device, laptop computer, desktop computer) that may be used to provide a previously requested token to a merchant computer 130.

The merchant computer 130 may be associated with a merchant. The merchant computer 130 may be an access device such as a POS terminal at a merchant location, a computer coupled with an access device of a merchant, or a remote server computer that hosts and/or operates a web site operated by the merchant. In some embodiments, the merchant operating the merchant computer 130 may be a card-on-file (COF) merchant. The card-on-file merchant may store account information for the account holder 110 in a remote database for future payments (e.g., recurring or periodic payments). The merchant computer 130 may be configured to generate an authorization request message for a transaction that is initiated by the account holder 110.

The acquirer computer 140 may be operated by an acquirer. An acquirer is typically a system for an entity (e.g., a bank) that has a business relationship with a particular merchant, a wallet provider or another entity. The acquirer computer 140 may be communicatively coupled to the merchant computer 130 and the payment network computer 150 and may issue and manage an account of the merchant. In some embodiments, the acquirer computer 140 may forward the authorization request message to the payment network computer 150 and the authorization response message to the merchant computer 130 during a transaction to confirm processing of a payment transaction.

The payment network computer 150 may be configured to provide authorization services, and clearing and settlement services for payment transactions. A payment network computer 150 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system that processes authorization requests and a Base II system that performs clearing and settlement services. Furthermore, the payment processing network may include a server computer and may use any suitable wired or wireless telecommunications network, including the Internet. In some embodiments, the payment network computer 150 may forward an authorization request received from the acquirer computer 140 to the issuer computer 170 via a communication channel. The payment network computer 150 may further forward an authorization response message received from the issuer computer 170 to the acquirer computer 140.

The issuer computer 170 may be operated by an account issuer. Typically, the account issuer is an entity (e.g., a bank) that issues and maintains an account of the account holder 110. The account may be a credit, debit, prepaid, or any other type of account.

In some embodiments, the issuer computer 170 may be a computer comprising a processor and a tangible non-transitory computer readable medium coupled to the processor. The tangible non-transitory computer readable medium may comprise code, executable by the processor, for implementing a method. The method comprises receiving from a token issuer computer a user interface for providing a set of parameters to generate a payment token request rule. The method further comprises generating the set of parameters and sending the set of parameters to the token issuer computer.

The token issuer computer system 160 may be a stand-alone entity or may be coupled to, integrated into, and/or operated or managed by any of the entities shown in FIG. 1. The token issuer computer system 160 may issue tokens and may verify the status of tokens. In such cases, the token issuer computer system 160 may alternatively be referred to as a token verifier or token issuer. Additionally, in some embodiments, the token issuer and the token verifier may include separate entities and/or systems that may be configured to issue or generate tokens and validate or verify tokens.

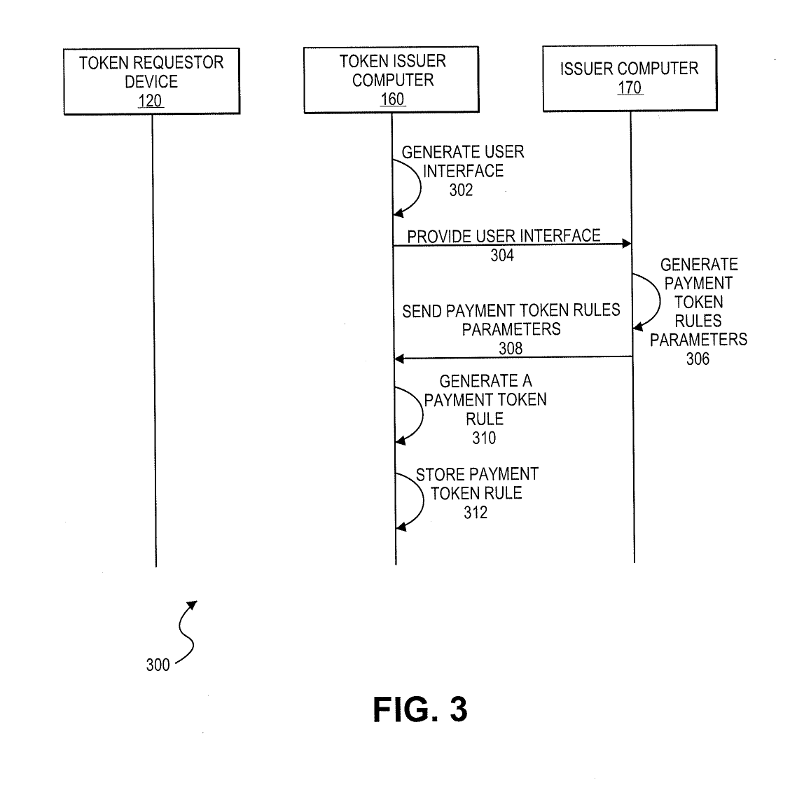

According to some embodiments of the present invention, the token issuer computer system 160 may be configured to perform a method including receiving a token request message from a token requestor device 120, generating a payment token, and providing the payment token to the token requestor device 120. Additionally, in some embodiments, the token issuer computer system 160 may verify payment tokens for a requestor. These methods are described in more detail below in reference to FIGS. 3-6.

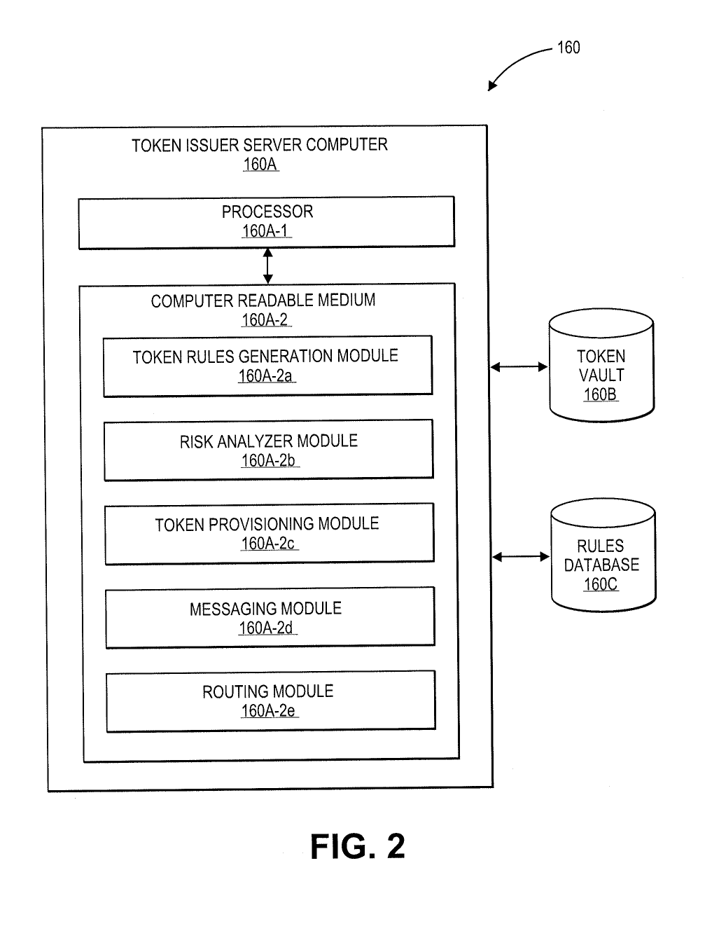

FIG. 2 depicts a block diagram of a token issuer computer system 160 according to an embodiment of the present invention. The token issuer computer system 160 depicted in FIG. 2 includes a number of components. It may comprise any suitable combination or subset of such components in various embodiments of the invention.

The token issuer computer system 160 may include a token issuer server computer 160A, and a token vault 160B and rules database 160C coupled to the token issuer server computer 160A.

The token issuer server computer 160A may include a processor 160A-1 and a computer readable medium 160A-2 coupled to the processor 160A-1. The computer readable medium 160A-2 may comprise code, executable by the processor 160A-1 for performing the functionality described in this application. The computer readable medium 160A-2 may store code for a token rules generation module 160A-2a, a risk analyzer module 160A-2b, a token provisioning module 160A-2c, a messaging module 160A-2d, and a routing module 160A-2e. Further details of the token issuer computer system 160 are described with respect to FIGS. 3-6 below.

The token rules generation module 160A-2a may operate in conjunction with the processor 160A-1 to generate payment token rules. The token rules generation module 160A-2a may also operate in conjunction with the processor 160A-1 to generate a user interface to allow an account issuer to manage and edit payment token request rules using a client computer.

The risk analyzer module 160A-2b may operate in conjunction with the processor 160A-1 to perform a risk analysis and determine a risk score associated with a payment token request. The risk analyzer module 160A-2b may also perform a risk analysis to examine the risks associated with other requests, including authentication requests and authorization requests for transactions.

The token provisioning module 160A-2c may operate in conjunction with the processor 160A-1 to issue payment tokens to a token requestor device 102 in response to a received payment token request message.

The messaging module 160A-2d may operate in conjunction with the processor 160A-1 to generate messages to be sent to the token requestor device 120 and the issuer computer 170. In some embodiments, the messaging module 160A-2d a may operate in conjunction with the processor 160A-1 to generate payment token response messages indicating the approval or denial of a payment token request. In some embodiments, the messaging module 160A-2d may operate in conjunction with the processor 160A-1 to generate authorization request messages for additional authorization of the payment token request.

The routing module 160A-2e may operate in conjunction with the processor 160A-1 to perform the routing of messages between computing devices. In some embodiments, the routing module 160A-2e may operate in conjunction with the processor 160A-1 to provide the issuer computer 170 with access to the user interface (e.g., by sending a web address to access the user interface) to allow the issuer computer 170 to provide the set of parameters for the payment token request rules. In some embodiments, routing module 160A-2e may operate in conjunction with the processor 160A-1 to perform the routing of token request related messages and transaction messages with the issuer computer 170. These messages may include authorization request and response messages.

The token vault 160B may be a database configured to store account information associated with a payment token, which may be accessed by the token issuer computer system 160 for tokenization and de-tokenization of sensitive information (e.g., payment account numbers).

The rules database 160C may be a database configured to store payment token request rules. The store payment token request rules stored in the rules database 160C may be generated based on the set of parameters provided by the issuer computer 170. In some embodiments, the payment token request rules stored in the rules database 160C may be stored in a profile associated with an account issuer and uniquely identified using an account issuer identifier to allow retrieval when a payment token request message is received by the token issuer computer system 160.

In some embodiments, the token issuer server computer 160A may be a computer comprising a processor and a tangible non-transitory computer readable medium coupled to the processor. The tangible non-transitory computer readable medium may comprise code, executable by the processor, for implementing a method. The method comprises receiving a set of parameters from a client computer operated by an account issuer. The method further comprises generating a payment token request rule based on the set of parameters and storing the payment token request rule. The method further comprises receiving a payment token request message, and applying the payment token request rule to the payment token request message. When the payment token request rule is satisfied, the method further comprises issuing a payment token.

The token issuer computer system 160 may interface with the token requestor device 120 using a token requestor API interface. The token requestor API interface may provide a standard interface for the token requestor device 120 to request and receive an issued payment token, request and receive information regarding whether a payment token is activated or deactivated, authenticate a received payment token, and/or manage the payment token through its lifecycle. Accordingly, a token requestor device 120 may request that a token be issued by the token issuer computer system 160, send a previously issued token (or message identifying the token) to the token issuer computer system 160 to activate or deactivate the payment token, send a request to the token issuer computer system 160 to authenticate the payment token, or provide a number of management functions regarding the lifecycle of the payment token. In some embodiments, the token issuer computer system 160 may communicate with an issuer or payment processing network to perform some or all of these functions.

The token issuer computer system 160 may communicate with the merchant computer 130 using merchant APIs. The token issuer computer system 160 may exchange tokens and process or route tokens to an appropriate entity for the merchant operating the merchant computer 130. Additionally, the token issuer computer system 160 may communicate with acquirer computer 140 through acquirer APIs. The acquirer APIs may standardize messaging between the merchant or acquirer computers 130, 140 such that the acquirer and/or merchant may exchange and route payment tokens. The standardized API interface may also support preferred debit routing so that particular networks may be used during payment token transaction routing.

The token issuer computer system 160 may interface with an issuer computer 170 using issuer APIs. The token issuer computer system 160 may issue payment tokens on behalf of the issuer using payment token request rules generated using a set of parameters provided by the issuer. The token issuer computer system 160 may also register and authenticate payment tokens for the issuer.

The token issuer computer system 160 may interface with the payment network computer 150 through the use of a network or a gateway API. In some embodiments, the payment network computer 150 or a gateway API may provide message and payment token translation between network processing systems.

### II. Exemplary Methods

Methods according to embodiments of the invention can be described with respect to FIGS. 1-9B.

FIG. 3 shows an exemplary flow diagram for a method of generating payment token request rules, according to an embodiment of the present invention.

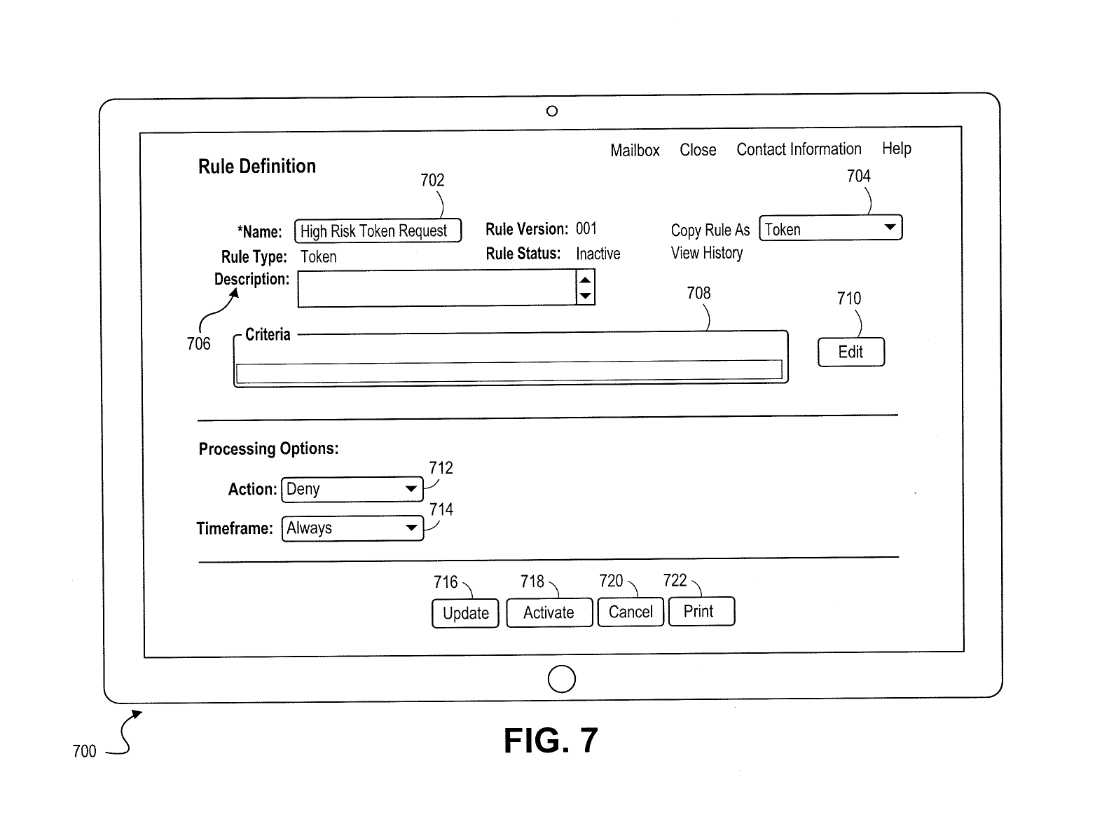

At step 302, a token issuer computer system 160 generates a user interface. In some embodiments, the processor 160A-1 and the token rules generation module 160A-2a may generate the user interface. FIGS. 7-9B show depictions of user interfaces for generation and updating of payment token request rules according to an embodiment of the present invention.

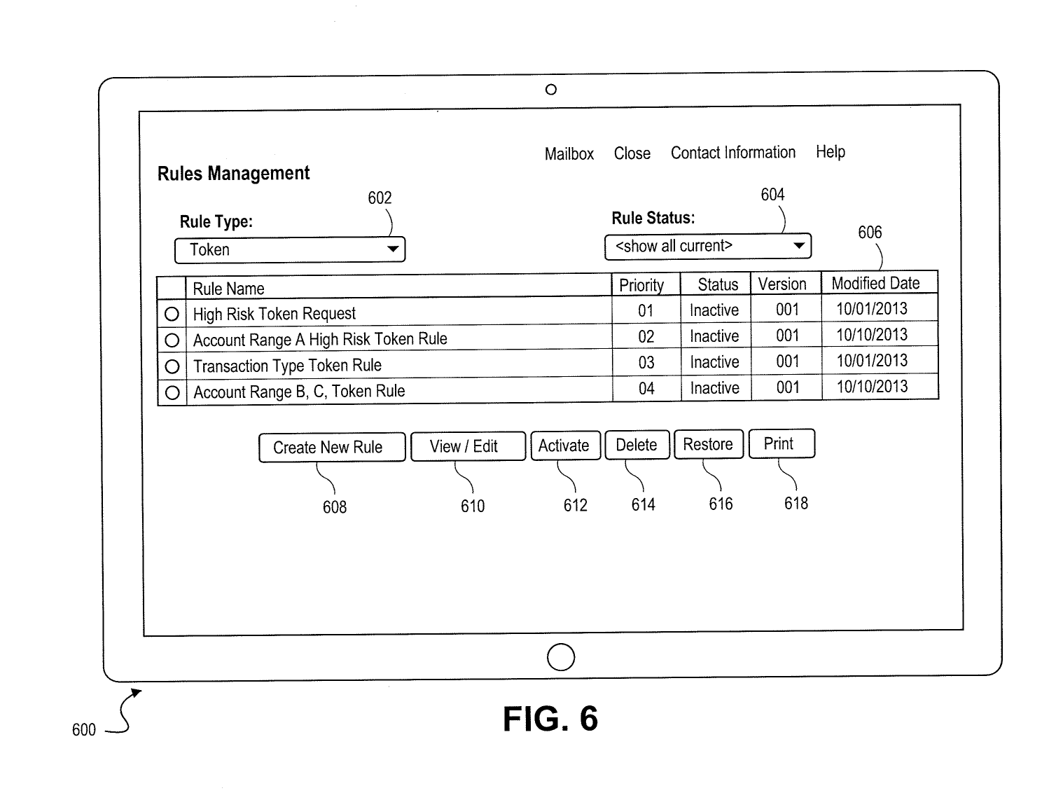

FIG. 6 shows a depiction of a rules management user interface 600 according to an embodiment of the present invention. In some embodiments, the rules management user interface 600 may allow a user to access payment token request rules associated with a profile.

As depicted in FIG. 6, the rules management user interface 600 may be an interface that includes a Rule Type menu 602, a Rule Status menu 604, a table of rules 606, and a series of options 608-618. The Rule Type menu 602 can allow a user (e.g., an account issuer) to select the types of rules to be displayed on the rules management user interface 600. For example, the user may be able to select from a plurality of options, including, “Token” rules, “Fraud” rules, all rules, new rules, etc. Based on the user's selection, the appropriate payment token request rules will be displayed on the rules management user interface 600.

The Rule Status menu 604 may allow the user to display rules of a selected type. In some embodiments, the user may be able to select from a plurality of options, including, “show all current,” “show all inactive rules,” and “show all active rules.”

The table of rules 606 may be a listing of payment token request rules, based on the Rule Type menu 602 and Rule Status menu 604 options selected by the user. The individual rule entries in the table of rules 606 may include a “Rule Name”, indicating an account issuer-customized name for a payment token request rule.

A “Priority” indicator in the table of rules 606 may be used to indicate the priority of a payment token request rule relative to other existing payment token request rules. In some embodiments, as shown in FIG. 6, the indicator may be a numerical value indicating the rank of the payment token request rule. In some embodiments, the user may be able to modify the priority of a payment token request rule by selecting the rule and modifying the payment token request rules position in the table of rules 606.

A “Status” indicator in the table of rules 606 may be used to indicate the status of the rule. In some embodiments, a payment token request rule may be “Active” or “Inactive”. A “Version” indicator may use a numeric or alphanumeric value to indicate the version of a rule. The “Modified Date” column may indicate the date that the payment token request rule was previously modified. The individual rule entries may also include a selection option (e.g., a radio button) that allows the user to select a particular rule for customization, modification, activation, deletion, etc.

The series of options 610-618 may include a “Create New Rule” option 608 that may present the user with rules definition user interface 700 of FIG. 7 to allow the user to create a new payment token request rule. The “View/Edit” option 610 may allow the user to select a preexisting rule from the table of rules 606 for viewing and/or editing to parameters. An “Activate” option 612 may allow the user to activate payment token request rules. The user may be able to activate payment token request rules for implementation in real-time using the “Activate” option 612.

A “Delete” option 614 may allow the user to delete payment token request rules from the table of rules 606. A “Restore” option 616 may allow the user to restore payment token request rules. For example, the user may be able to restore a payment token request rule to a previous version by selecting the “Restore” option 616. A “Print” option 618 may allow the user to print selected payment token request rules from the table of rules 606.

At step 304, the token issuer computer system 160 provides the user interface to an issuer computer 170. In some embodiments, the processor 160A-1 and routing module 160A-2e may provide data representing the user interface to an issuer computer 170 for display on a client computer associated with the account issuer. In some embodiments, the token issuer computer system 160 may provide the user interface by providing a web address (e.g., URL) for the account issuer to access.

At step 306, the issuer computer 170 generates a set of parameters for a payment token request rule. The set of parameters may be provided to the token issuer computer system 160 via a user interface. FIG. 7 shows a depiction of a rules definition user interface 700 according to an embodiment of the present invention.

In some embodiments, when the user selects the “Create New Rule” option 608 on the rules management user interface 600, the user may be presented with the rules definition user interface 700 as shown in FIG. 7. As depicted in FIG. 7, the rules definition user interface 700 may be an interface that includes a “Name” field 702, a “Copy Rule As” menu 704, a “Description” field 706, a “Criteria Table” 708, an “Edit” button 710, an “Action” menu 712, a “Timeframe” menu 714 and a series of option 716-722.

The “Name” field 702 may be a customizable text field that a user may use to provide a name for a payment token request rule. The “Copy Rule As” menu 704 may be a menu that allows a user to establish a rule type for the payment token request rule (e.g., Token Rule, Fraud Rule, General Rule, Core Rule). The “Description” field 706 may be a customizable text field that a user may use to provide a detailed description for a payment token request rule.

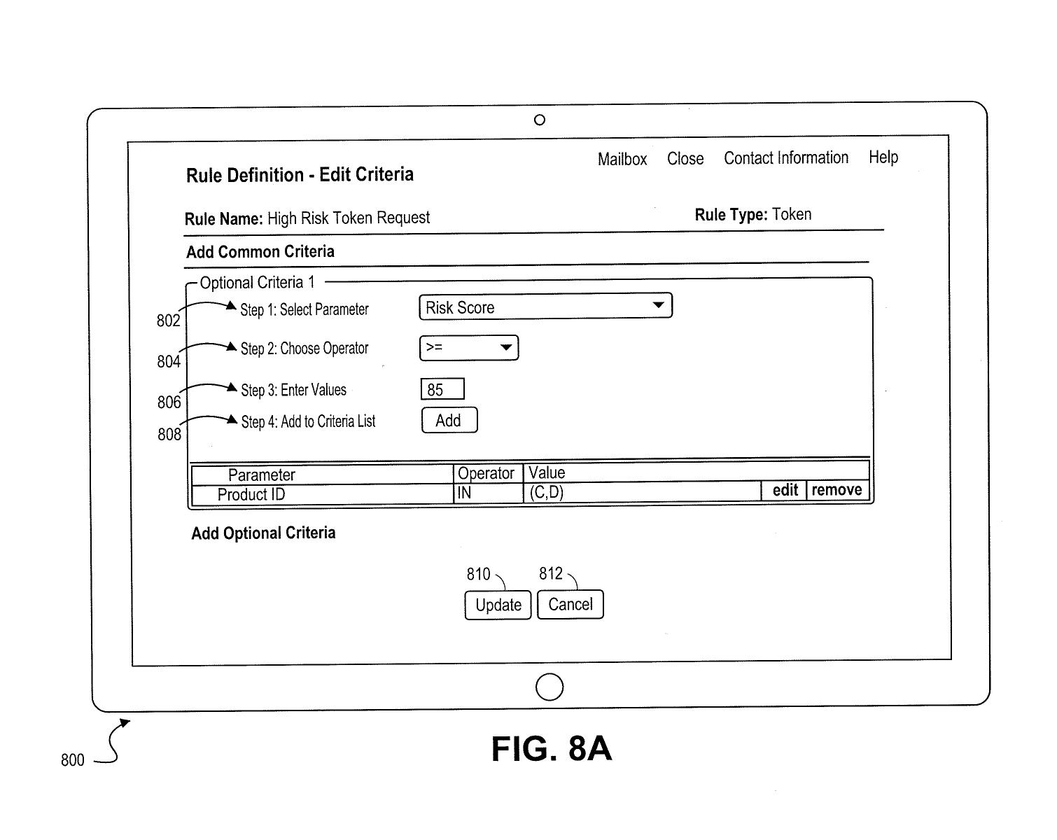

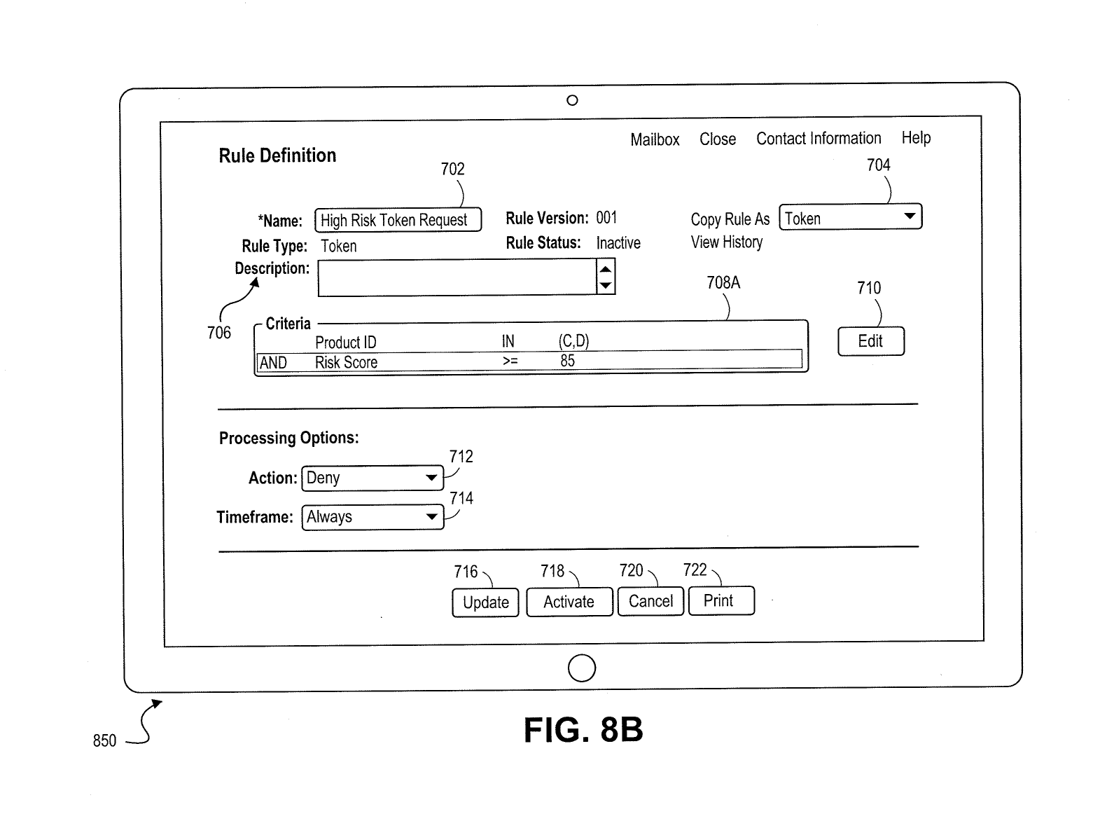

The “Criteria Table” 708 may include one or more parameters associated with the payment token request rule that are evaluated to determine whether the payment token request rule has been triggered. The “Edit” button 710 may allow the user to edit the one or more parameters associated with the payment token request rule, as well as add new parameters. In the example shown in FIG. 7, no criteria have been provided for the payment token request rule named “High Risk Token Request”. In some embodiments, when the user selects the “Edit” button 710 on rules definition user interface 700, the user may be presented with the rules editor user interface 800 as shown in FIG. 8A.

The “Action” menu 712 may allow the user to define the type of action to take with respect to received payment token requests that match the user-defined criteria in the table of criteria 708. In some embodiments, the options may include, “Deny,” “Approve,” and “Further Review.” Other embodiments may include additional or fewer options.

In some embodiments, when the token issuer computer system 160 receives a payment token request message from a token requestor 120, the token issuer computer system 160 may parse the payment token request message to retrieve a set of parameters and an account identifier. The account identifier may be used to identify an account associated with the token requestor 120. The token issuer computer system 160 may perform an action associated with any triggered payment token request rules.

In some embodiments, when the action associated with the triggered token request rule is to “Further Review” the payment token request, the processor 160A-1 and the token provisioning module 160A-2c may be configured to perform advanced authentication processes (e.g., using a password) or send the payment token request message to the issuer computer 170 in an authorization request message. For example, if a triggered payment token request rule has an action to perform a further review of the payment token request when a risk score is above 60 and below 85, when the result of a risk analysis is a risk score is between 60 and 85, the payment token request may be sent to the issuer computer 170 for additional analysis and final decisioning.

In some embodiments, when the action associated with the triggered payment token request rule is to “Deny” the payment token request, the payment token request may be denied. For example, if a triggered payment token request rule has an action to deny the payment token request when a risk score is above 85, when the result of a risk analysis is a risk score of above 85, the payment token request will be denied.

In some embodiments, when the action associated with the triggered payment token request rule is to “Approve” the payment token request, the processor 160A-1 and the token provisioning module 160A-2c may be configured to generate a payment token associated with the user identifier, and provide the payment token to the token requestor 120. In such embodiments, the processor 160A-1 and the token provisioning module 160A-2c may be configured to store information related to the payment token in the token vault. For example, if a triggered payment token request rule has an action to approve the payment token request when a risk score is below 30, when the result of a risk analysis is a risk score of below 30, the payment token request will be approved.

The “Timeframe” menu 714 may allow the user to define when a payment token request rule is active and applicable to payment token requests. In some embodiments, the options may include, “Always,” “Days of the Week,” and “Stand in Processing (STIP) Only.” Other embodiments may include additional or fewer options.

With the “Days of the Week” option, the user may be able to select specific days of the weeks and the hours that the payment token request rules should be applied to incoming payment token requests. When a payment token request is received at a time not included in the options denied by the user using the “Days of the Week” option, the payment token request rules will not be applied.

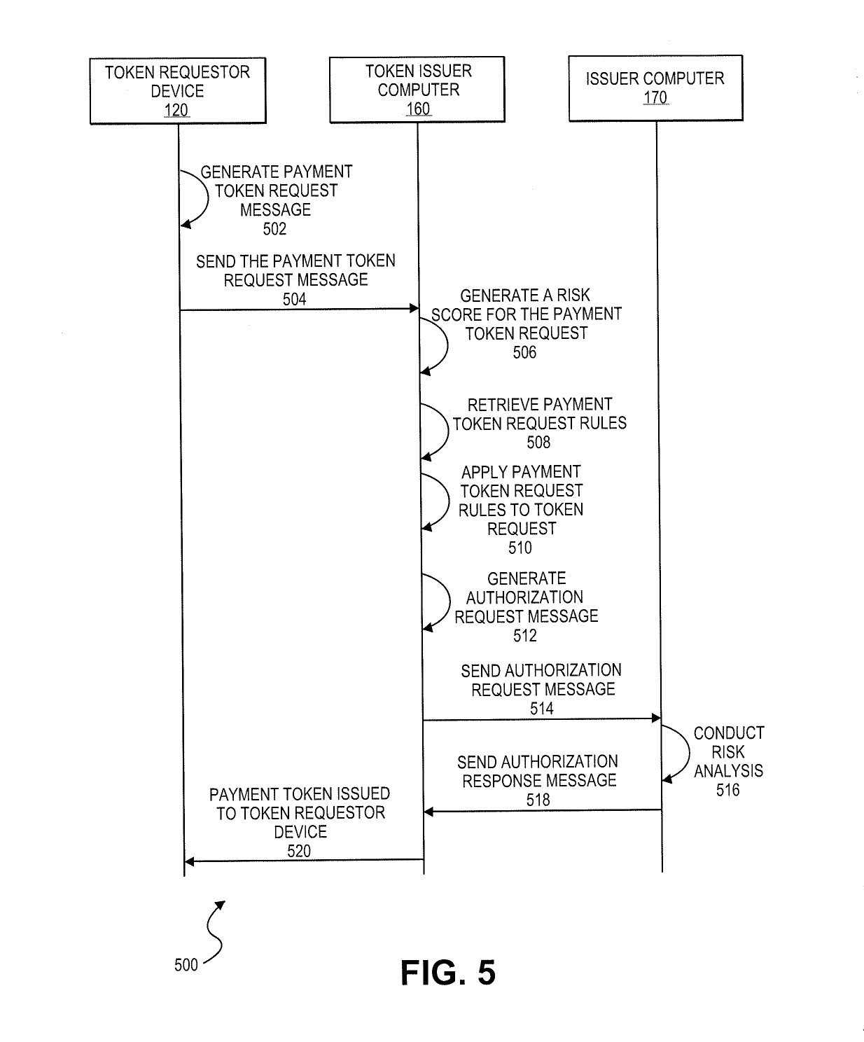

With the “STIP Only” option, the system may only respond when the issuer computer 170 is unable to reply to the authorization within a pre-determined timeframe. In some embodiments, the STIP rules for payment token requests may only apply when the token issuer computer 160 has to generate an authorization request message for sending to the issuer computer 170 for additional decisioning (as described above, with respect to steps 514-518 of FIG. 5).

The series of options 716-722 may include an “Update” option 716 to update a pre-existing payment token request rule. In some embodiments, when the user selects the “Update” option 716, any changes or modifications made to the payment token request rule may be saved to the rules database 160C. The “Activate” option 718 may be selected by the user to activate the payment token request rule that is currently being modified by the user. A “Cancel” option 720 may be selected to cancel any modifications made to the payment token request rule and prevent the modifications from being saved to the rules database 160C. A “Print” option 722 may allow the user to print the current settings for a payment token request rule, as displayed in the rules definition user interface 700.

FIG. 8A shows a depiction of a rules editor user interface 800 according to an embodiment of the present invention. As shown in FIG. 8A, the user may be presented with a set of fields in which the user can provide parameters. In the embodiment shown in FIG. 8A, the user may be provided a “Parameter” field 802, an “Operator” field 804, a “Value” field 806, and an “Add” button 808.

The “Parameter” field 802 may provide the user with options for different data elements to analyze when a payment token request message is received. In some embodiments, parameters that may be used as criteria for a payment token request rule may include a risk score, a token requestor identifier, a token requestor account identifier, a device type, an account range, a card product identifier, a token requestor account status, a token requestor account score, a reason code, and a device score. In addition, parameters may be based on a number of PANs linked to an account, a number of accounts linked to a PAN, a number of devices linked to the token requestor, a number of accounts linked to a device, a number of IP addresses linked to an account, and a number of accounts linked to an IP address.

The “Operator” menu 804 may allow the user to select an operation associated with the numerical value provided in the “Value” field 806. Example operators may include: “=”, “>”, “<”, “!=”. When the user has completed entering in the parameters 802-806, the user may select the “Add” button 808 to add the new or edited criteria to the payment token request rule.

In the example shown in FIG. 8A, the user has provided parameters that a High Risk Token Request Rule is triggered when the risk score is greater than or equal to “85”.

At step 308, the issuer computer 170 provides the set of parameters to the token issuer computer system 160. When the account issuer has completed all the fields in the rules editor user interface 800, the user can select to update the payment token request rule by selecting the “Update” button 810. When the user selects the “Update” button 810, the set of parameters entered by the user in the rules editor user interface 800 may then be sent to the token issuer computer system 160 and the user may be returned to the rules definition user interface 700 shown in FIG. 7.

At step 310, the token issuer computer system 160 generates the payment token request rule using the received set of parameters. The token issuer computer system 160 may receive the set of parameters from the issuer computer 170 (or a client computer associated with the account issuer).

Once token issuer computer system 160 has received the set of parameters from the issuer computer 170, the processor 160A-1 and the token rules generation module 160A-2a may generate the payment token request rule. The generated payment token request rule may be presented in a modified rules definition user interface 850, as shown in FIG. 8B.

As shown in FIG. 8B, the user-defined criteria in the table of criteria 708A has been modified, from the rules definition user interface 700 depicted in FIG. 7, to include criteria based on determining whether a card product identifier matches product groups C or D, as well as the risk score criteria described above with respect to FIG. 8A. Thus, as shown in the example of FIG. 8B, when a payment token request includes the card product ID in product groups C or D (e.g., the payment account is associated with a commercial account or a prepaid account) and the risk score generated by the token issuer computer system 160 is greater than or equal to 85, the payment token request will be denied.

Additional examples of payment token request rules may include determining if a reason code received with the payment token request from the token requestor 120 indicates that there is a fraud risk associated with the payment token request, or the token requestor 120 provided a score for the account that indicates that the payment token request is risky.

At step 312, the token issuer computer system 160 stores the payment token request rule. In some embodiments, the processor 160A-1 and the token rules generation module 160A-2a may store the payment token request rule in a rules database 160C coupled to the token issuer computer system 160. In some embodiments, the payment token request rule may be stored in a profile associated with the account issuer. The profile may be specific for the account issuer and include previously generated payment token request rules associated with the account issuer. In such embodiments, an account issuer identifier may also be associated with the profile to allow retrieval of the profile and payment token request rules contained therein.

In some embodiments, once the payment token request rules have been generated and stored, they can be activated in real-time for immediate use for application to incoming payment token request messages.

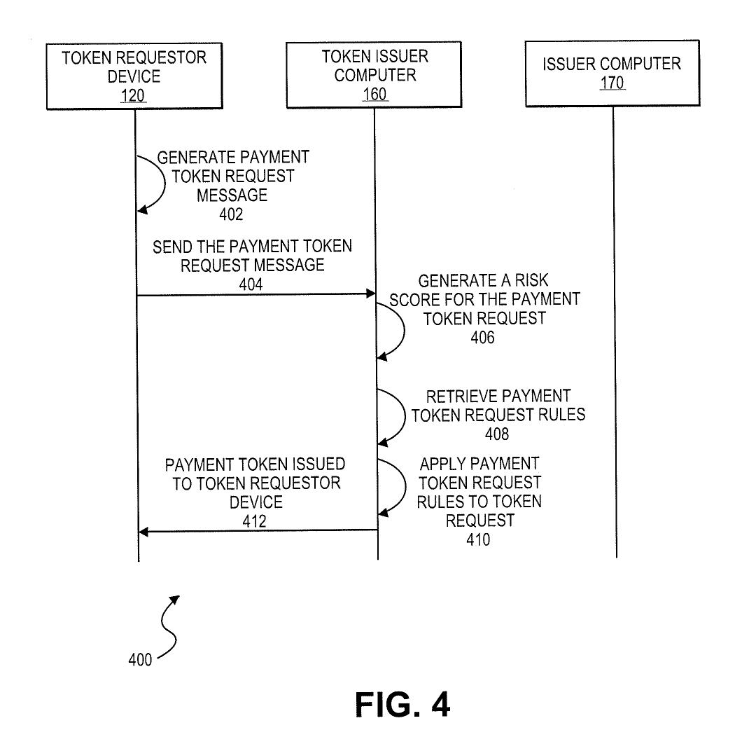

FIG. 4 shows an exemplary flow diagram for a method of applying a payment token request rule to a payment token request according to an embodiment of the present invention.

At step 402, a token requestor device 120 generates a payment token request message. In some embodiments the payment token request message may be generated by the token requestor device 120 in response to an action by an account holder 110 to initiate the payment token issuance process. In some embodiments, the payment token request message generated by the token requestor device 120 may be secured using encryption (e.g., encrypting the payment token request using a public key provided by the token issuer), hashing, random numbers, or any other suitable methods. In such embodiments, the payment token request message may be later decrypted by the token issuer computer system 160 using a private key.

In one embodiment, the token requestor device 120 may undergo an onboarding or registration process to ensure that the token requestor meets integration and security standards in order to utilize the tokenization services provided. For example, services such as account registration, token generation, token issuance, token authentication and activation, token exchange, and token life-cycle management to the registered entities may be provided. Upon registration, the token requestor device 120 may receive a token requestor identifier to associate it with certain configuration preferences.

At step 404, the token requestor device 120 may send the generated payment token request message to the token issuer computer system 160. In some embodiments, the token requestor device 120 may provide a token requestor identifier or other credentials in the payment token request message as part of the request as a form of identification. The payment token request message may include a plurality of data elements, including a user account identifier, an account issuer identifier, account holder data, and a device identifier. The token request and any other communication messages described herein may be sent using any suitable communication networks and/or protocols (e.g., using HTTPS, SOAP and/or an XML interface among others).

At step 406, the token issuer computer system 160 may generate a risk score for the payment token request. In some embodiments, the processor 160A-1 and the risk analyzer module 160A-2b may be configured to perform a risk analysis using one or more of the data elements received in the payment token request message. The risk analysis may be based on token requestor device data, account data, and user data. The result of the risk analysis may be a risk score. The risk score may be a numeric value with a relative value based on the configuration of the token issuer computer system 160.

At step 408, the token issuer computer system 160 may retrieve one or more payment token request rules. The token issuer computer system 160 may retrieve the payment token request rules from a rules database 160C. In some embodiments, the token issuer computer system 160 may retrieve an account issuer identifier from the payment token request message. The account issuer identifier may be a unique identifier for the account issuer, such as a bank identification number (“BIN”). The account issuer identifier may be used to identify and retrieve payment token request rules previously generated and associated with the account issuer.

At step 410, the token issuer computer system 160 applies the payment token request rules to the payment token request message. In some embodiments, determining whether to issue a payment token may be based on the application of the payment token request rules to the payment token request. For example, one criterion for a payment token request rule may involve comparing a risk score with a risk threshold defined in the payment token request rules (e.g., 85 established in the example payment token request rule described above). In some embodiments, when the risk score is on a first side of the threshold (e.g., below the threshold), the payment token request may be deemed to be low risk. In such situations, the system may proceed to issue the payment token to the token requestor device 120. In some embodiments, when the risk score is on a second side of the threshold (e.g., above the threshold), the payment token request may be deemed to be high risk. In such situations, the system may deny the payment token request or may additional authentication and/or authorization processes.

In other embodiments, the token issuer computer system 160 may retrieve data elements from the payment token request message. In such embodiments, the token issuer computer system 160 may determine whether to issue a token to the token requestor device 120 based on evaluating the data elements in the payment token request message with the pre-defined account issuer payment token request rules.

At step 412, the token issuer computer system 160 may issue and send the payment token to the token requestor device 120. In some embodiments, the processor 160A-1 and the token provisioning module 160A-2c may generate a payment token response message including the payment token. The payment token response message may include the generated payment token as well as any other relevant information to identify the token issuer, the user and/or account holder associated with the payment token response, and any other relevant information to the token request. If the payment token request is not authorized (e.g., high risk), the token issuer computer system 160 may not generate a payment token and instead include an indication of the failed token request result in the payment token response message.

In some embodiments, when authentication of the account holder 110 is required prior to issuance of the payment token, the token issuer computer system 160 may generate a password, or other secure data element. The token issuer computer system 160 may send the generated password to the issuer computer 170. The issuer computer may receive the generated password from the token issuer computer system 160 and end the password to a token requestor device 120. The password may then be provided by the account holder 110 to the token issuer computer system 160 using the token requestor device 120 in order to authenticate the account holder as being in possession of the token requestor device 120.

FIG. 5 shows an exemplary flow diagram for an alternative method of applying a payment token request rule to a payment token request according to an embodiment of the present invention.

At steps 502-510, a token requestor device 120 may generate a payment token request message and send the payment token request message to the token issuer computer system 160. The token issuer computer system 160 may generate a risk score for the payment token request message and apply payment token request rules to the token request. The process in steps 502-510 may be performed as described previously in steps 402-410, respectively, of FIG. 4.

At step 512, in some embodiments, when the payment token request rule is not satisfied, the token issuer computer system 160 may generate an authorization request message including the data from the payment token request message. In such embodiments, the issuer computer 170 may establish that payment token requests be sent to the issuer computer 170 for additional authentication or authorization. In some embodiments, the authorization request message may be an ISO 8583 message, or any other comparable message types. In some embodiments, the authorization request message may be a $0 or no amount transaction message to authenticate the account holder 110. In such embodiments, the authorization request message may include an indicator or field to denote that the authorization request message is related to a payment token request as opposed to a transaction.

At step 514, the authorization request message may be sent to the issuer computer 170 by the token issuer computer system 160. In such embodiments, the authorization request message may be sent to the issuer computer 170 for approval of the payment token request. In some embodiments, the risk score determined by the token issuer computer system 160 may also be sent to the issuer computer 170 with the authorization request message to assist in the decisioning process.

At step 516, the issuer computer 170 may conduct an additional risk analysis to determine whether the payment token should be issued in response to the payment token request. In some embodiments, the issuer computer 170 may have additional data related to the account holder 110 and the account, and may use this data to perform the additional risk analysis. For example, the issuer computer 170 may have user personal information (e.g., email address), additional location-based data related to the user based on user GPS data and/or IP address data, and third party risk scoring data. The result of the risk analysis may be a risk score or risk level indicating the riskiness of the payment token request. Based on the result of the risk analysis, the issuer computer 170 may determine whether the payment token should be issued or denied.

At step 518, the issuer computer 170 may generate and send an authorization response message to the token issuer computer system 160. The authorization response message may indicate the result of the authorization process performed by the issuer and may indicate whether the payment token should be issued to the token requestor device 120.

At step 520, the token issuer computer system 160 may send the payment token to the token requestor device 120, as described previously in step 412 of FIG. 4.

### III. Technical Benefits

Embodiments of the present invention may provide a number of advantages including performing the issuance of payment tokens without requiring an account issuer to develop any of the infrastructure needed to handle payment token requests. Embodiments of the present invention also provide the benefit of allowing the account issuer to define when token request should be approved, denied, or sent for further review (e.g., stepped-up authentication). Allowing an account issuer to tailor their own account issuer-specific payment token request rules for determining when payment token requests, allows payment tokens to be issued based on the account issuer's specific business model.

Additionally, performing a risk analysis provides the benefit of greater confidence to an account issuer that a payment token is being generated for an authenticated account holder using a legitimate PAN. Using payment token request rules and risk scores may provide a token issuing system that more efficiently denies improper payment token request and approves proper payment token requests. As the token issuer computer may perform the payment token issuance determination on behalf of the issuer computer, rather than by sending the payment token request to the issuer computer, the process of issuing payment tokens may be streamlined and performed faster.

### IV. Exemplary Apparatuses

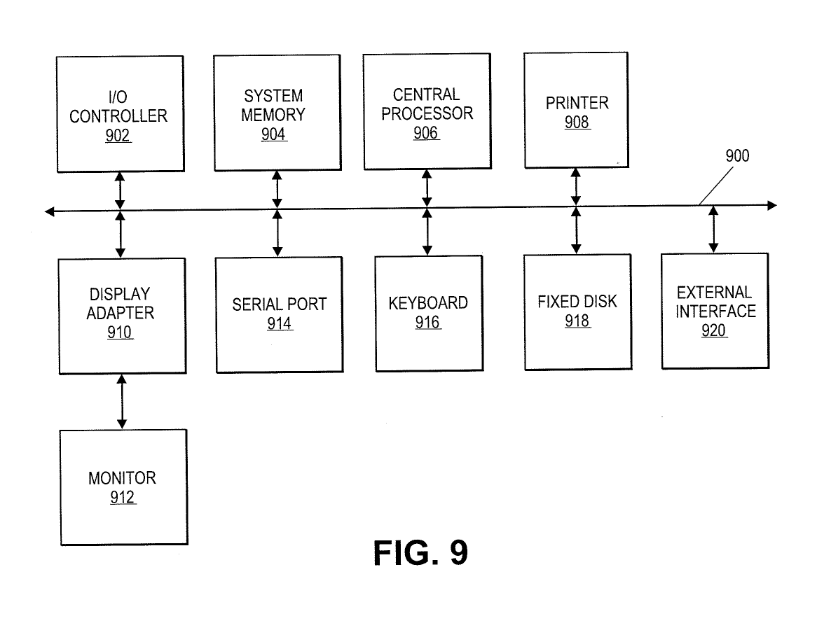

Examples of such subsystems or components are shown in FIG. 9. Any of the subsystems or components shown in FIG. 9 can be included in any of the previously described devices, apparatuses, or systems. The subsystems shown in FIG. 9 are interconnected via a system bus 900. Additional subsystems such as a printer 908, keyboard 914, fixed disk 916 (or other memory comprising computer readable media), monitor 920, which is coupled to display adapter 910, and others are shown. Peripherals and input/output (I/O) devices, which couple to I/O controller 902 (which can be a processor or other suitable controller), can be connected to the computer system by any number of means known in the art, such as serial port 912. For example, serial port 912 or external interface 918 can be used to connect the computer apparatus to a wide area network such as the Internet, a mouse input device, or a scanner. The interconnection via system bus allows the central processor 906 to communicate with each subsystem and to control the execution of instructions from system memory 904 or the fixed disk 916, as well as the exchange of information between subsystems. The system memory 904 and/or the fixed disk 916 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

In some embodiments, any of the entities described herein may be embodied by a computer that performs any or all of the functions and steps disclosed.

One or more features from any embodiment may be combined with one or more features of any other embodiment without departing from the scope of the technology.

Any recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, at a server computer, a set of parameters from a client computer operated by an account issuer;
generating, by the server computer, a payment token request rule based on the set of parameters;
storing, by the server computer, the payment token request rule;
receiving, by the server computer, a payment token request message;
applying, by the server computer, the payment token request rule to the payment token request message; and
issuing, by the server computer, a payment token when the payment token request rule is satisfied.

2. The method of claim 1, wherein applying the payment token request rule to the token request message further comprises:
generating, by the server computer, a risk score associated with the payment token request message;
retrieving, by the server computer, the payment token request rule from a database using an identifier; and
evaluating, by the server computer, the payment token request rule with the risk score.

3. The method of claim 1, wherein applying the payment token request rule to the token request message further comprises:
retrieving, by the server computer, the payment token request rule from a database using an identifier; and
evaluating, by the server computer, data elements in the payment token request message with the payment token request rule.

4. The method of claim 1, wherein when the payment token request rule is not satisfied, the method further comprises:
generating, by the server computer, an authorization request message, the authorization request message including the payment token request message;
sending, by the server computer, the authorization request message to the client computer for approval of the payment token request message; and
receiving, by the server computer, an authorization response message from the client computer; and
issuing, by the server computer, the payment token when the authorization response message approves issuance of the payment token.

5. The method of claim 1, wherein sending the authorization request message to the client computer further comprises:
sending, by the server computer, a risk score associated with the payment token request message to the client computer.

6. A computer comprising:
a processor; and
a tangible non-transitory computer readable medium coupled to the processor, the tangible non-transitory computer readable medium comprising code, executable by the processor for implementing a method comprising:
receiving a set of parameters from a client computer operated by an account issuer;
generating a payment token request rule based on the set of parameters;
storing the payment token request rule;
receiving a payment token request message;
applying the payment token request rule to the payment token request message; and
issuing a payment token when the payment token request rule is satisfied.

7. The computer of claim 6, wherein applying the payment token request rule to the token request message further comprises:
generating a risk score associated with the payment token request message;
retrieving the payment token request rule from a database using an identifier; and
evaluating the payment token request rule with the risk score.

8. The computer of claim 6, wherein applying the payment token request rule to the token request message further comprises:
retrieving the payment token request rule from a database using an identifier; and
evaluating data elements in the payment token request message with the payment token request rule.

9. The computer of claim 6, wherein when the payment token request rule is not satisfied, the method further comprises:
generating an authorization request message, the authorization request message including the payment token request message;
sending the authorization request message to the client computer for approval of the payment token request message; and
receiving an authorization response message from the client computer; and
issuing the payment token when the authorization response message approves issuance of the payment token

10. The computer of claim 6, wherein sending the authorization request message to the client computer further comprises:
sending a risk score associated with the payment token request message to the client computer.

11. A method comprising:
receiving, by a server computer, from a token issuer computer a user interface for providing a set of parameters to generate a payment token request rule;
generating, by the server computer, the set of parameters; and
sending, by the server computer, the set of parameters to the token issuer computer.

12. The method of claim 11, wherein the set of parameters include an action to perform when the payment token request rule is not satisfied.

13. The method of claim 12, wherein the action is an account issuer authentication process, and wherein the method further comprises:
receiving, by the server computer, an authorization request message associated with a payment token request message;
performing, by the server computer, a risk analysis to determine a risk score for the payment token request message;
generating, by the server computer, an authorization response message; and
sending, by the server computer, the authorization response message to the token issuer computer for issuance of a payment token when the risk score is on a first side of a risk threshold, and wherein the payment token is not issued when the risk score is on a second side of the risk threshold.

14. The method of claim 11, further comprising:
receiving, by the server computer, a password from the token issuer computer when additional authentication of a token requestor is required for the token request message; and
sending, by the server computer, the password to a token requestor device, wherein the password is provided to the token issuer computer to authenticate the token requestor.

15. The method of claim 11, wherein the set of parameters includes a risk score, an account issuer identifier, an account range, and a token requestor device type.

16. A computer comprising:
a processor; and
a tangible non-transitory computer readable medium coupled to the processor, the tangible non-transitory computer readable medium comprising code, executable by the processor for implementing a method comprising:
receiving from a token issuer computer a user interface for providing a set of parameters to generate a payment token request rule;
generating the set of parameters; and
sending the set of parameters to the token issuer computer.

17. The computer of claim 16, wherein the set of parameters include an action to perform when the payment token request rule is not satisfied.

18. The computer of claim 17, wherein the action is an account issuer authentication process, and wherein the method further comprises:
receiving an authorization request message associated with a payment token request message;
performing a risk analysis to determine a risk score for the payment token request message;
generating an authorization response message; and
sending the authorization response message to the token issuer computer for issuance of a payment token when the risk score is on a first side of a risk threshold, and wherein the payment token is not issued when the risk score is on a second side of the risk threshold.

19. The computer of claim 16, further comprising:
receiving a password from the token issuer computer when additional authentication of a token requestor is required for the token request message; and
sending the password to a token requestor device, wherein the password is provided to the token issuer computer to authenticate the token requestor.

20. The computer of claim 16, wherein the set of parameters includes a risk score, an account issuer identifier, an account range, and a token requestor device type.
